(19) United States
(12) Patent Application Publication
(10) Pub. No.: US 2025/0350138 A1
(43) Pub. Date: Nov. 13, 2025

(54) CONTROLLER WITH VARIABLE X-CAPACITOR DISCHARGING MECHANISM AND RELATED OPERATIONAL METHOD

(71) Applicant: Leadtrend Technology Corp., Hsinchu County (TW)

(72) Inventors: Yi-Chuan Tsai, Hsinchu County (TW); Yi-Ling Chen, Hsinchu County (TW); Ming-Yen Lin, Hsinchu County (TW)

(73) Assignee: Leadtrend Technology Corp., Hsinchu County (TW)

(21) Appl. No.: 19/181,392

(22) Filed: Apr. 17, 2025

Related U.S. Application Data
(60) Provisional application No. 63/638,428, filed on Apr. 25, 2024.

(51) Int. Cl. H02J 7/00; H02J 7/34

(52) U.S. Cl. CPC H02J 7/00712; H02J 7/345

(57) ABSTRACT

A controller with variable X-capacitor discharging mechanism includes a voltage detection circuit and a discharging circuit, wherein the controller is applied to a power converter and the X-capacitor is coupled to the power converter. The voltage detection circuit is used for receiving a detection voltage through a pin of the controller and determining whether to generate a discharging signal according to variation of the detection voltage, wherein the detection voltage is generated by an input voltage inputted to the power converter, the input voltage is an alternating current input voltage or a direct current input voltage, and the discharging signal lasts for a predetermined period of time. The discharging circuit is coupled to the voltage detection circuit and the pin, wherein the discharging circuit is used for discharging the X-capacitor according to the discharging signal.

### CROSS REFERENCE TO RELATED APPLICATIONS

This application claims the benefit of U.S. Provisional Application No. 63/638,428, filed on Apr. 25, 2024. The content of the application is incorporated herein by reference.

### BACKGROUND OF THE INVENTION

### 1. FIELD OF THE INVENTION

The present invention relates to a controller with X-capacitor discharge and a related operational method, and particularly to a controller with variable X-capacitor discharging mechanism and a related operational method.

### 2. DESCRIPTION OF THE PRIOR ART

In the prior art, a common X-capacitor discharging mechanism is that when a detection voltage detected by a controller has continuous periodic variation, an input voltage inputted to a power converter is regarded as an alternating current voltage by the controller and the controller does not actively discharge the X-capacitor. However, once a voltage source providing the input voltage is removed, the detection voltage related to the X-capacitor does not have periodic variation no more (i.e. when the voltage source providing the input voltage is removed, there is a residual voltage on the X capacitor and the residual voltage does not have a continuous periodic variation), resulting in the controller actively discharging the X-capacitor to release the residual voltage to meet requirements of a safety specification.

However if when the input voltage is a direct current voltage, because the detection voltage detected by the controller does not have continuous periodic variation, the controller actively discharges the X-capacitor continuously, which easily causes a risk of damage and over-temperature of the controller. Therefore, how to design the controller with variable X-capacitor discharging mechanism has become an important issue of a designer of the controller.

### SUMMARY OF THE INVENTION

An embodiment of the present invention provides a controller with variable X-capacitor discharging mechanism, wherein the controller is applied to a power converter and the X-capacitor is coupled to the power converter, and the controller includes a voltage detection circuit and a discharging circuit. The voltage detection circuit is used for receiving a detection voltage through a pin of the controller and determining whether to generate a discharging signal according to variation of the detection voltage, wherein the detection voltage is generated by an input voltage inputted to the power converter, the input voltage is an alternating current input voltage or a direct current input voltage, and the discharging signal lasts for a predetermined period of time. The discharging circuit is coupled to the voltage detection circuit and the pin, wherein the discharging circuit is used for discharging o the X-capacitor according to the discharging signal.

According to one aspect of the invention, the pin is coupled to two ends of the X-capacitor and the X-capacitor is coupled to a bridge rectifier comprised in the power converter.

According to one aspect of the invention, when the input voltage is the alternating current input voltage and the detection voltage does not have periodic variation within a first predetermined period of time, the voltage detection circuit generates the discharging signal after the first predetermined period of time and the discharging circuit discharges the X-capacitor through a discharging current and the pin, wherein the predetermined period of time is greater than the first predetermined period of time.

According to one aspect of the invention, during the first predetermined period of time, the controller enables X-capacitor discharge detection, brown-out protection detection and over-load protection detection.

According to one aspect of the invention, during the predetermined period of time, the controller disables the brown-out protection detection and the over-load protection detection, the controller enables the brown-out protection detection again and disables the X-capacitor discharge detection after the predetermined period of time is finished, and after a second predetermined period of time after the controller enables the brown-out protection detection again and when the detection voltage is less than a first reference voltage, the controller enables brown-out protection, wherein the first reference voltage relates to the brown-out protection detection.

According to one aspect of the invention, when the input voltage is the direct current input voltage and the detection voltage is a fixed value during the first predetermined period of time, the voltage detection circuit generates the discharging signal after the first predetermined period of time and the discharging circuit discharges the X-capacitor through a discharging current and the pin, wherein the predetermined period of time is greater than the first predetermined period of time.

According to one aspect of the invention, during the first predetermined period of time, the controller enables X-capacitor discharge detection, brown-out protection detection and over-load protection detection.

According to one aspect of the invention, during the predetermined period of time, the controller disables the brown-out protection detection and the over-load protection detection, the controller enables the brown-out protection detection again and disables the X-capacitor discharge detection after the predetermined period of time is finished, and after a second predetermined period of time after the controller enables the brown-out protection detection again and when the detection voltage is less than a first reference voltage, the controller enables brown-out protection, wherein the first reference voltage relates to the brown-out protection detection.

According to one aspect of the invention, during the predetermined period of time, the controller disables the brown-out protection detection and the over-load protection detection, the controller enables the brown-out protection detection again and disables the X-capacitor discharge detection after the predetermined period of time is finished, wherein during the predetermined period of time, the detection voltage is greater than a first reference voltage.

According to one aspect of the invention, after a third predetermined period of time after the predetermined period of time is finished, when the detection voltage is the fixed value and greater than a second reference voltage, the controller enables the over-load protection detection again, wherein the second reference voltage relates to the over-load protection detection.

According to one aspect of the invention, when the voltage detection circuit does not generate one detection signal during a fourth predetermined period of time after the voltage detection circuit generates detection signals according to periodic variation of the detection voltage, the voltage detection circuit generates the discharging signal after the fourth predetermined period of time.

According to one aspect of the invention, when the detection voltage is less than a detection reference voltage after the detection voltage reaches a peak value, the voltage detection circuit generates one detection signal.

According to one aspect of the invention, the voltage detection circuit does not generate one detection signal during a fifth predetermined period of time after a voltage source provides an input voltage to the power converter to let the power converter power on, the voltage detection circuit does not generate the discharging signal after the fifth predetermined period of time.

According to one aspect of the invention, the pin is coupled to an output terminal of a bridge rectifier comprised in the power converter, and the X-capacitor is coupled to the bridge rectifier.

According to one aspect of the invention, when the input voltage is the alternating current input voltage and the detection voltage is a fixed value during a first predetermined period of time, the controller disables X-capacitor detection and continuously enables brown-out protection detection and over-load protection detection, wherein the fixed value is greater than a first reference voltage and a second reference voltage, the first reference voltage relates to the brown-out protection detection, and the second reference voltage relates to the over-load protection detection

According to one aspect of the invention, when the input voltage is the direct current input voltage and the detection voltage is a fixed value during a first predetermined period of time, the controller disables discharge X-capacitor detection and continuously enables brown-out protection detection and over-load protection detection, wherein the fixed value is greater than a first reference voltage and a second reference voltage, the first reference voltage relates to the brown-out protection detection, and the second reference voltage relates to the over-load protection detection.

Another embodiment of the present invention provides an operational method of a controller with variable X-capacitor discharging mechanism, wherein the controller is applied to a power converter, the X-capacitor is coupled to the power converter, and the controller comprises a voltage detection circuit and a discharging circuit. The operational method includes the voltage detection circuit receiving a detection voltage through a pin of the controller, and determining whether to generate a discharging signal according to variation of the detection voltage, wherein the detection voltage is generated by an input voltage inputted to the power converter, the input voltage is an alternating current input voltage or a direct current input voltage, and the discharging circuit discharging the X-capacitor according to the discharging signal.

According to one aspect of the invention, when the input voltage is the alternating current input voltage and the detection voltage does not have periodic variation within a first predetermined period of time, the voltage detection n circuit generates the discharging signal after the first predetermined period of time, wherein the predetermined period of time is greater than the first predetermined period of time.

According to one aspect of the invention, when the input voltage is the direct current input voltage and the detection voltage is a fixed value within the first predetermined period of time, the voltage detection circuit generates the discharging signal after the first predetermined period of time, wherein the predetermined period of time is greater than the first predetermined period of time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller with variable X-capacitor discharging mechanism according to a first embodiment of the present invention.

FIG. 2 is a timing diagram illustrating the detection voltage, a discharging current, the discharging signal, X-capacitor discharge detection, brown-out protection detection, brown-out protection and over-load protection detection related to operation of the controller when the input voltage is an alternating current (AC) input voltage.

FIG. 3 is a timing diagram illustrating the detection voltage, the input voltage, the discharging current, the discharging signal, the X-capacitor discharge detection, the brown-out protection detection, the brown-out protection and the over-load protection detection related to operation of the controller when the input voltage is a direct current (DC) input voltage.

FIG. 4 is a timing diagram illustrating the detection voltage, the input voltage, the discharging current, the discharging signal, the X-capacitor discharge detection, the brown-out protection detection and the over-load protection detection related to operation of the controller when the input voltage is a DC input voltage.

FIG. 5, FIG. 6 and FIG. 7 are timing diagrams illustrating the detection voltage, the X-capacitor discharge and a detection signal related to operation of the controller based on FIG. 1 according to a second embodiment of the present invention.

FIG. 8 is a diagram illustrating a controller with variable X-capacitor discharging mechanism according to a third embodiment of the present invention.

FIG. 9 is a timing diagram illustrating the detection voltage, the X-capacitor discharge detection, the brown-out protection detection and the over-load protection detection related to operation of the controller based on FIG. 8 when the input voltage is an alternating current input voltage.

FIG. 10 is a timing diagram illustrating the detection voltage, the X-capacitor discharge detection, the brown-out protection detection and the over-load protection detection related to operation of the controller based on FIG. 8 when the input voltage is a direct current input voltage.

FIG. 11A and FIG. 11B are flowcharts illustrating an operational method of the controller with variable X-capacitor discharging mechanism according to a fourth embodiment of the present invention.

FIG. 12 is a flowchart illustrating an operational method of the controller with variable X-capacitor discharging mechanism according to a fifth embodiment of the present invention.

### DETAILED DESCRIPTION

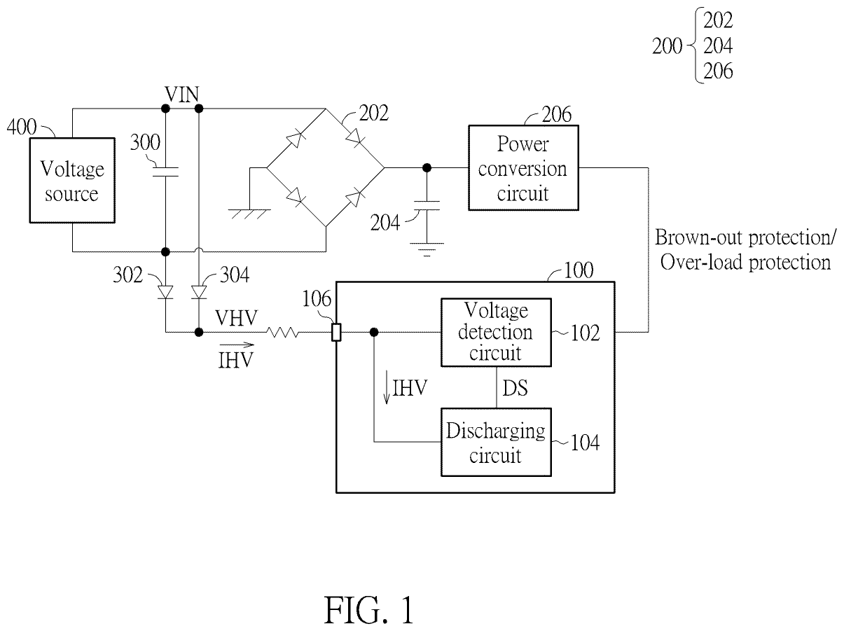

Please refer to FIG. 1. FIG. 1 is a diagram illustrating a controller 100 with variable X-capacitor discharging mechanism according to a first embodiment of the present invention, wherein the controller 100 is applied to a primary side of a power converter 200 and includes a voltage detection circuit 102 and a discharging circuit 104, and coupling relationships between the voltage detection circuit 102 and the discharging circuit 104 can be referred to FIG. 1, so further description thereof is omitted for simplicity. In addition, as shown in FIG. 1, because the power converter 200 is not a key technical feature of the present invention, the power converter 200 only shows a bridge rectifier 202, a capacitor 204 and a power conversion circuit 206. In addition, as shown in FIG. 1, the present invention is not limited to the controller 100 only includes the voltage detection circuit 102 and the discharging circuit 104. That is to say, the controller 100 can include other functional circuits (not shown in FIG. 1).

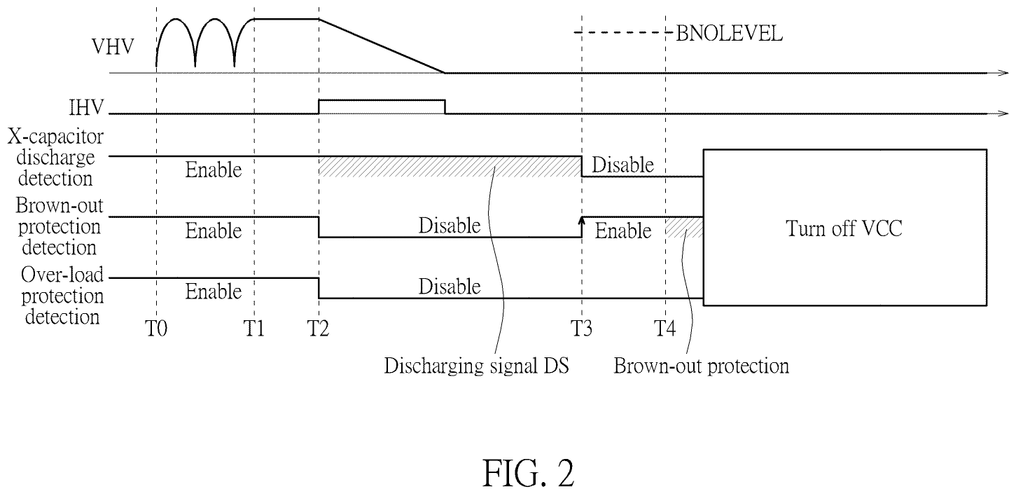

As shown in FIG. 1, a high voltage pin 106 of the controller 100 is coupled to two ends of an X-capacitor 300 and the X-capacitor 300 is coupled to the bridge rectifier 202, and the voltage detection circuit 102 can receive a detection voltage VHV through the high voltage pin 106 and determine whether to generate a discharging signal DS according to variation of the detection voltage VHV, wherein the detection voltage VHV is generated by an input voltage VIN inputted to the power converter 200, and the input voltage VIN is provided by a voltage source 400. Next, please refer to FIG. 2. FIG. 2 is a timing diagram illustrating the detection voltage VHV, a discharging current IHV, the discharging signal DS, X-capacitor discharge detection, brown-out protection detection, brown-out protection and over-load protection detection related to operation of the controller 100 when the input voltage VIN is an alternating current (AC) input voltage, wherein both the brown-out protection and the over-load protection are related to the power converter 200. As shown in FIG. 2, after the voltage source 400 provides the input voltage VIN to the power converter 200 to let the power converter 200 power on for a period of time, between the time T0 and the time T1, because the detection voltage VHV is generated by the input voltage VIN passing diodes 302, 304, one of ordinary skilled in the art should know that the voltage detection circuit 102 can continuously detect the detection voltage VHV with periodic variation, wherein between the time T0 and the time T1, the controller 100 enables the X-capacitor discharge detection, the brown-out protection detection and the over-load protection detection, and the X-capacitor discharge detection, the brown-out protection detection the over-load protection detection relates to the other functional circuits of the controller 100. As shown in FIG. 2, at the time T1, the voltage source 400 is removed, so meanwhile the input voltage VIN is residual voltage on the X-capacitor 300, resulting in the detection voltage VHV detected by the voltage detection circuit 102 between the time T1 and the time T2 (i.e. a first predetermined period of time) not having periodic variation so that the voltage detection circuit 102 determines that the input voltage VIN disappears, wherein the first predetermined period of time depends on practical design requirements (for example the first predetermined period of time is (not limited to) 50 ms), and the controller 100 continuously enables the X-capacitor discharge detection, the brown-out protection detection and the over-load protection detection during the first predetermined period of time. Next, the voltage detection circuit 102 generates the discharging signal DS to the discharging circuit 104 after the time T2 and the discharging circuit 104 discharges the X-capacitor 300 through the discharging current IHV and the high voltage pin 106, wherein the discharging signal DS and the discharging current IHV last for a predetermined period of time to the time T3, the predetermined period of time also depends on practical design requirements (for example the predetermined period of time is (not limited to) 230 ms), and the predetermined period of time is greater than the first predetermined period of time. In addition, as shown in FIG. 2, at the time T2, the other functional circuits of the controller 100 also disable the brown-out protection detection and the over-load protection detection, and the other functional circuits of the controller 100 enables the brown-out protection detection again and disables the X-capacitor discharge detection after the predetermined period of time is finished (i.e. at the time T3), wherein after the predetermined period of time is finished, because the voltage source 400 is removed and the discharging circuit 104 discharges the X-capacitor 300 through the discharging current IHV and the high voltage pin 106 during the predetermined period of time, the detection voltage VHV will be less than a first reference voltage BNOLEVEL, and the first reference voltage BNOLEVEL relates to the brown-out protection detection. In addition, in one embodiment of the present invention, when the other functional circuits of the controller 100 enable the brown-out protection detection again, the over-load protection detection is still disabled. As shown in FIG. 2, at a second predetermined period of time (i.e. at the time T4) after the time T3, the controller 100 enables the brown-out protection, wherein the second predetermined period of time depends on practical design requirements (for example the second predetermined period of time is (not limited to) 70 ms). Next, as shown in FIG. 2, after the controller 100 enables the brown-out protection, the controller 100 enters a protection mode and is turned off, and the controller 100 is turned off by (for example) turning off or removing a supply voltage VCC which is used for the operation of the controller 100.

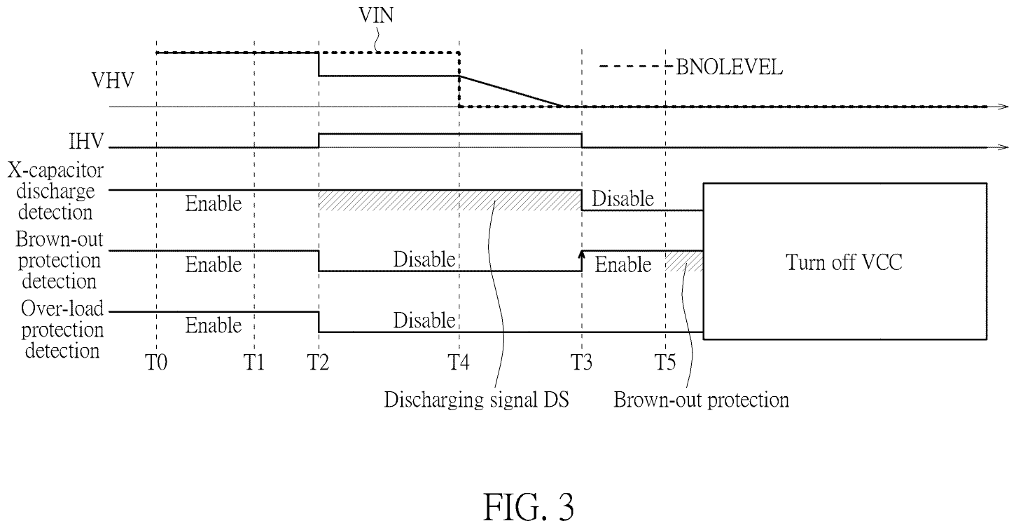

Next, please refer to FIG. 3. FIG. 3 is a timing diagram illustrating the detection voltage VHV, the input voltage VIN, the discharging current IHV, the discharging signal DS, the X-capacitor discharge detection, the brown-out protection detection, the brown-out protection and the over-load protection detection related to operation of the controller 100 when the input voltage VIN is a direct current (DC) input voltage, wherein both the brown-out protection and the over-load protection are related to the power converter 200. As shown in FIG. 3, after the voltage source 400 provides the input voltage VIN to the power converter 200 to let the power converter 200 power on for a period of time, between the time T0 and the time T1, because the detection voltage VHV is generated by the input voltage VIN passing the diodes 302, 304, if a voltage drop on the diodes 302, 304 is neglected, the detection voltage VHV is substantially equal to the input voltage VIN (i.e. the detection voltage VHV is a fixed value), wherein the controller 100 enables the X-capacitor discharge detection, the brown-out protection detection and the over-load protection detection, and the X-capacitor discharge detection, the brown-out protection detection and the over-load protection detection are related to the other functional circuits of the controller 100. As shown in FIG. 3, because the detection voltage VHV is a DC voltage, the detection voltage VHV detected by the voltage detection circuit 102 between the time T1 and the time T2 (i.e. the first predetermined period of time) does not have variation, wherein for example, the first predetermined period of time depends on practical design requirements (for example the first predetermined period of time is (not limited to) 50 ms), and the controller 100 continuously enables the X-capacitor discharge detection, the brown-out protection detection and the over-load protection detection during the first predetermined period of time. Next, the voltage detection circuit 102 generates the discharging signal DS to the discharging circuit 104 after the time T2 and the discharging circuit 104 discharges the X-capacitor 300 through the discharging current IHV and the high voltage pin 106, wherein the discharging signal DS and the discharging current IHV last for the predetermined period of time to the time T3, the predetermined period of time depends on practical design requirements (for example the predetermined period of time is (not limited to) 230 ms), and the predetermined period of time is greater than the first predetermined period of time. In addition, as shown in FIG. 3, at the time T2, the other functional circuits of the controller 100 also disable the brown-out protection detection and the over-load protection detection, and the other functional circuits of the controller 100 enables the brown-out protection detection again and disables the X-capacitor discharge detection after the predetermined period of time is finished (i.e. at the time T3). As shown in FIG. 3, during the predetermined period of time (i.e. at the time T4), because voltage source 400 is removed, the detection voltage VHV will be less than the first reference voltage BNOLEVEL, and the first reference voltage BNOLEVEL relates to the brown-out protection detection. As shown in FIG. 3, at a second predetermined period of time (i.e. at the time T5) after the time T3, the controller 100 enables the brown-out protection, wherein the second predetermined period of time depends on practical design requirements (for example the second predetermined period of time is (not limited to) 70 ms). Next, as shown in FIG. 3, after the controller 100 enables the brown-out protection, the controller 100 enters the protection mode and is turned off, and the controller 100 is turned off by (for example) turning off or removing the supply voltage VCC which is used for the operation of the controller 100.

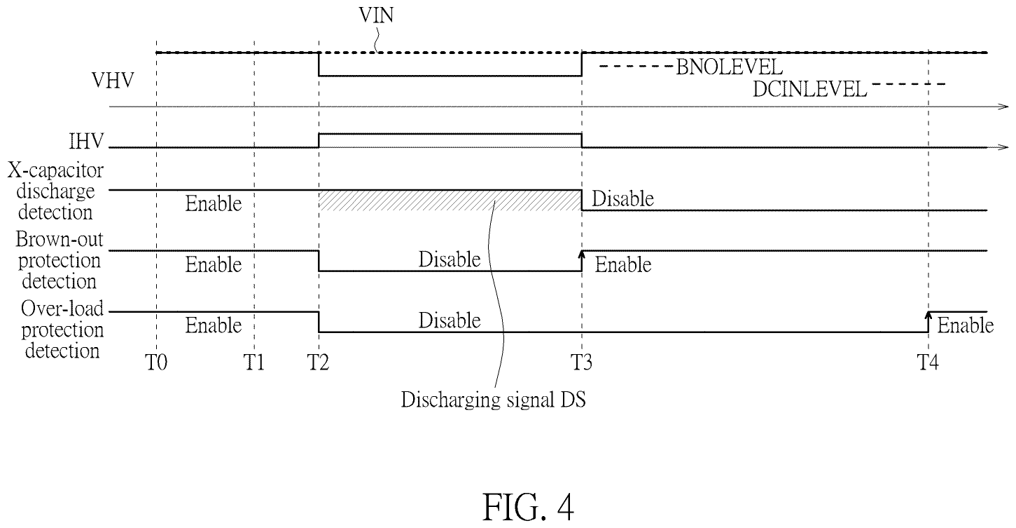

Next, please refer to FIG. 4. FIG. 4 is a timing diagram illustrating the detection voltage VHV, the input voltage VIN, the discharging current IHV, the discharging signal DS, the X-capacitor discharge detection, the brown-out protection detection and the over-load protection detection related to operation of the controller 100 when the input voltage VIN is a DC input voltage, wherein both the brown-out protection and the over-load protection are related to the power converter 200. As shown in FIG. 4, before the time T2, the detection voltage VHV, the input voltage VIN, the discharging current IHV, the discharging signal DS, the X-capacitor discharge detection, the brown-out protection detection and the over-load protection detection are the same as those in FIG. 3, so further description thereof is omitted for simplicity. Next, the voltage detection circuit 102 generates the discharging signal DS to the discharging circuit 104 after the time T2 and the discharging circuit 104 discharges the X-capacitor 300 through the discharging current IHV and the high voltage pin 106, wherein the discharging signal DS and the discharging current IHV last for the predetermined period of time to the time T3. In addition, as shown in FIG. 4, at the time T2, the other functional circuits of the controller 100 also disable the brown-out protection detection and the over-load protection detection, and the other functional circuits of the controller 100 enables the brown-out protection detection again and disables the X-capacitor discharge detection after the predetermined period of time is finished (i.e. at the time T3). As shown in FIG. 4, when the predetermined period of time is finished (i.e. at the time T3), because the voltage source 400 is not removed, the detection voltage VHV is not less than the first reference voltage BNOLEVEL, resulting in the controller 100 not enabling the brown-out protection after the time T3. In addition, as shown in FIG. 4, after a third predetermined period of time (i.e. at the time T4) after the predetermined period of time is finished, because the voltage source 400 is not removed, the detection voltage VHV is also greater than a second reference voltage DCINLEVEL, resulting in the controller 100 enabling the over-load protection again, wherein the third predetermined period of time depends on practical design requirements (for example the third predetermined period of time is (not limited to) 230 ms).

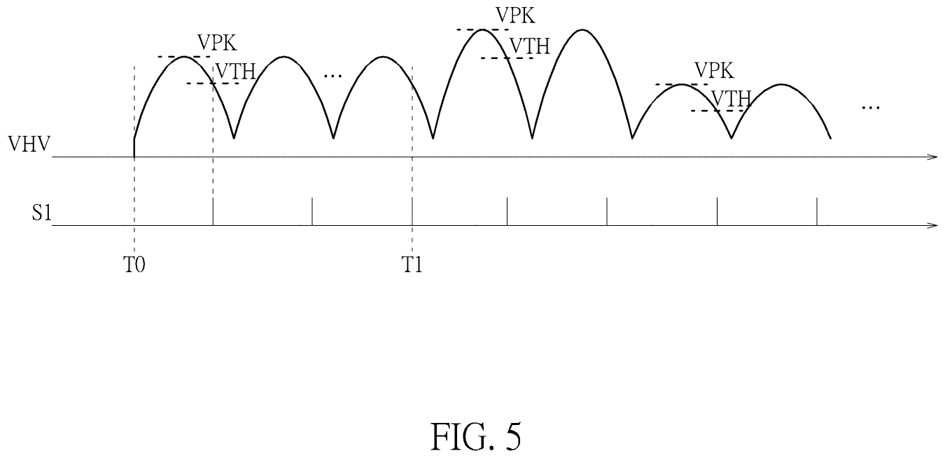

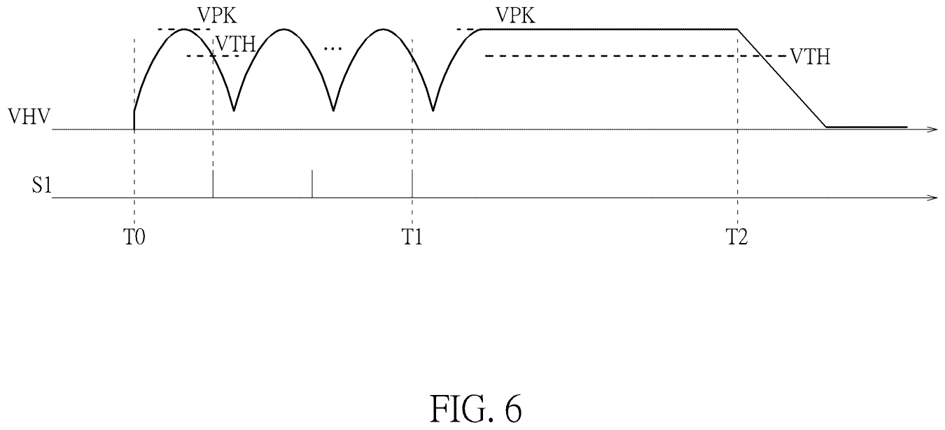

Next, please refer to FIG. 5, FIG. 6 and FIG. 7. FIG. 5, FIG. 6 and FIG. 7 are timing diagrams illustrating the detection voltage VHV, the X-capacitor discharge and a detection signal S1 related to operation of the controller 100 based on FIG. 1 according to a second embodiment of the present invention. As shown in FIG. 5, at the time T0, the voltage source 400 provides the input voltage VIN to the power converter 200 to let the power converter 200 power on. Between the time T0 and the time T1, because the voltage detection circuit 102 generates M detection signals S1 according to periodic variation of the detection voltage VHV, the voltage detection circuit 102 determines that the voltage source 400 is an alternating current voltage source at the time T1, wherein M is a positive integer, and M depends on practical design requirements. In addition, when the detection voltage VHV is less than a detection reference voltage VTH after the detection voltage VHV reaches a peak value VPK, the voltage detection circuit 102 can generate one detection signal S1, wherein in one embodiment of the present invention, the detection reference voltage VTH can be N times the peak value VPK (wherein 1>N>0) or the detection reference voltage VTH is equal the peak value VPK minus a fixed voltage. As shown in FIG. 6, between the time T1 and the time T2 (i.e. a fourth predetermined period of time, wherein the fourth predetermined period of time also depends on practical design requirements (for example the fourth predetermined period of time is (not limited to) 50 ms), the voltage detection circuit 102 does not generate any detection signal, the voltage detection circuit 102 determines that the voltage source 400 is removed and generates the discharging signal DS after the fourth predetermined period of time (i.e. after the time T2). Then, the discharging circuit 104 discharges the X-capacitor 300 through the discharging current IHV and the high voltage pin 106, resulting in the detection voltage VHV being gradually reduced after the time T2.

As shown in FIG. 7, between the time T0 and the time T1 (i.e. a fifth predetermined period of time, wherein the fifth predetermined period of time also depends on practical design requirements (for example the fifth predetermined period of time is (not limited to) 50 ms), because the detection voltage VHV does not have periodic variation, the voltage detection circuit 102 does not generate any detection signal. Therefore, the voltage detection circuit 102 determines that the voltage source 400 is a DC voltage source at the time T1 and does not generate the discharging signal DS. That is to say, after the voltage detection circuit 102 determines that the voltage source 400 is a DC voltage source at the time T1, the voltage detection circuit 102 will disable a function of discharging the X-capacitor 300.

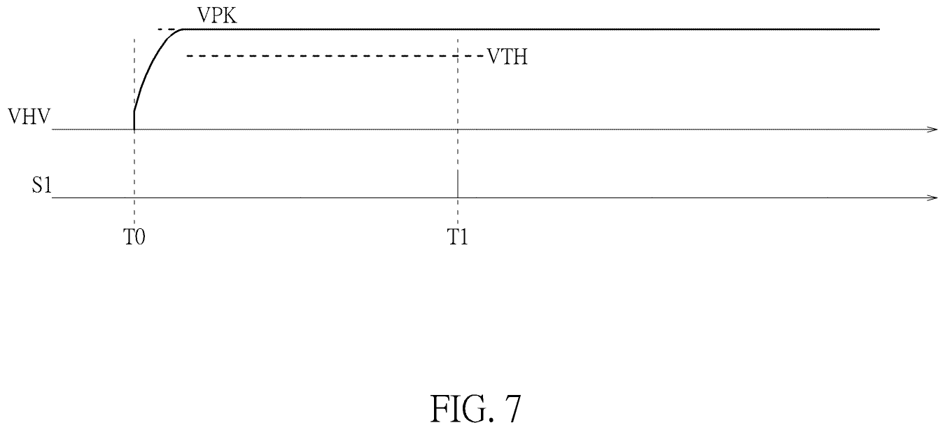

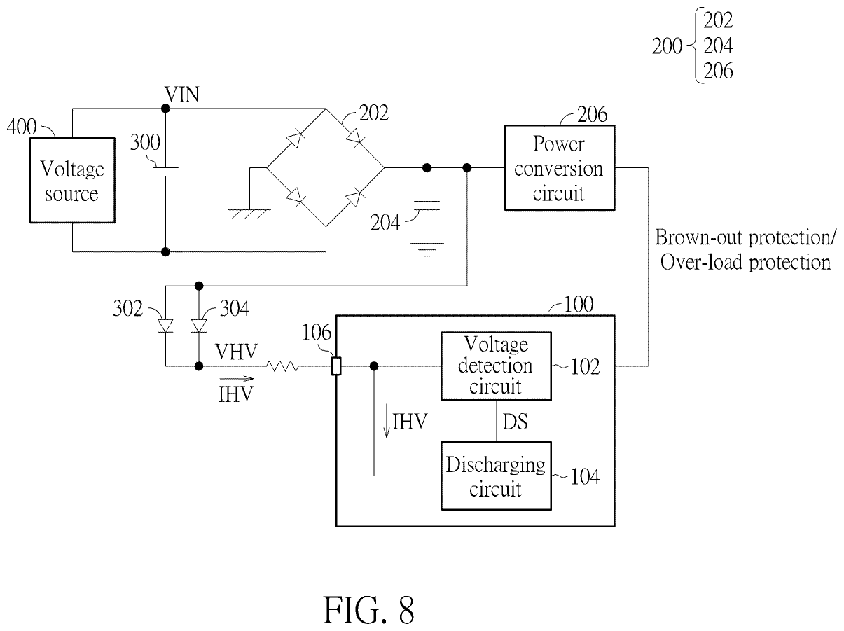

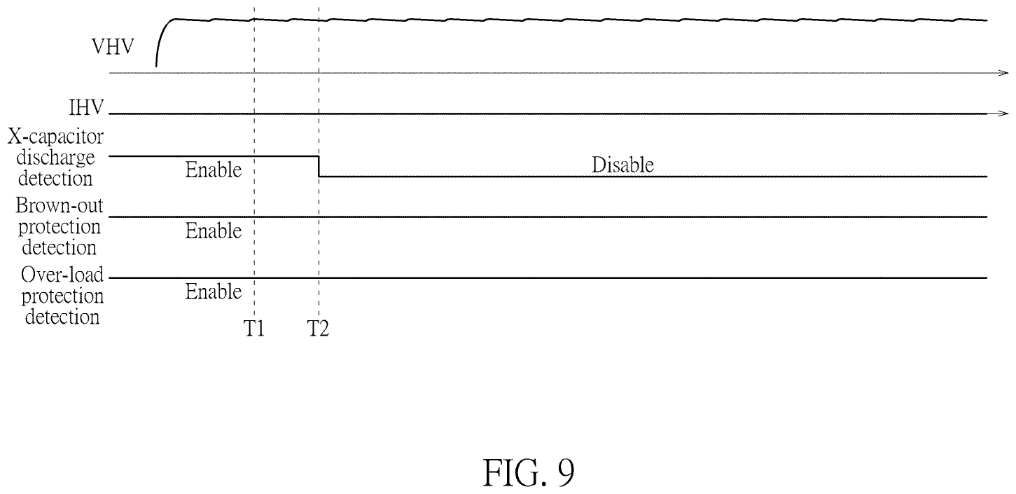

Please refer to FIG. 8. FIG. 8 is a diagram illustrating a controller 100 with variable X-capacitor discharging mechanism according to a third embodiment of the present invention, wherein a difference between FIG. 8 and FIG. 1 is that the high voltage pin 106 of the controller 100 is coupled to an output terminal of the bridge rectifier 202. In addition, coupling relationships between the voltage detection circuit 102, the discharging circuit 104, the bridge rectifier 202, the capacitor 204, the power conversion circuit 206, the X-capacitor 300 and the voltage source 400 can be referred to FIG. 8, so further description thereof is omitted for simplicity. Next, please refer to FIG. 9. FIG. 9 is a timing diagram illustrating the detection voltage VHV, the X-capacitor discharge detection, the brown-out protection detection and the over-load protection detection related to operation of the controller 100 based on FIG. 8 when the input voltage VIN is an alternating current input voltage. As shown in FIG. 9, after the voltage source 400 provides the input voltage VIN to the power converter 200 to let the power converter 200 power on for a period of time, because the high voltage pin 106 is coupled to the output terminal of the bridge rectifier 202 and the capacitor 204 has a very large capacitance, at the time T1, the input voltage VIN can be substantially regarded as a fixed value, wherein the fixed value is greater than the first reference voltage and the second reference voltage, the first reference voltage relates to the brown-out protection detection, and the second reference voltage relates to the over-load protection detection. Therefore, if when the detection voltage VHV detected by the voltage detection circuit 102 between the time T1 and the time T2 (i.e. the first predetermined period of time) is continuously at the fixed value, the controller 100 disables the X-capacitor discharge detection and continuously enables the brown-out protection detection and the over-load protection detection. Of course, if when the detection voltage VHV detected by the voltage detection circuit 102 between the time T1 and the time T2 is continuously at the fixed value, the controller 100 can operate according to FIG. 4 after the time T2.

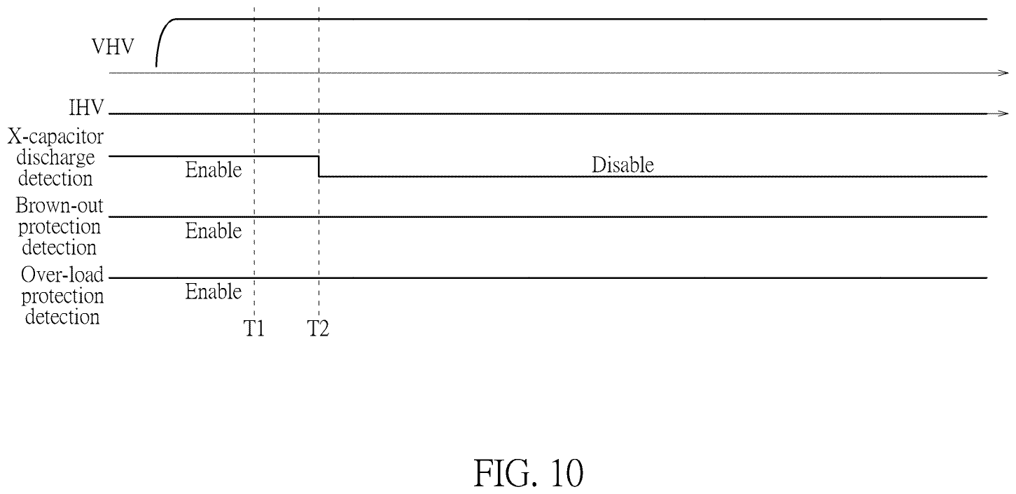

Please refer to FIG. 10. FIG. 10 is a timing diagram illustrating the detection voltage VHV, the X-capacitor discharge detection, the brown-out protection detection and the over-load protection detection related to operation of the controller 100 based on FIG. 8 when the input voltage VIN is a direct current input voltage. As shown in FIG. 10, after the voltage source 400 provides the input voltage VIN to the power converter 200 to let the power converter 200 power on for a period of time, because the input voltage VIN is the direct current input voltage, at the time T1, the input voltage VIN is a fixed value, wherein the fixed value is greater than the first reference voltage and the second reference voltage, the first reference voltage relates to the brown-out protection detection, and the second reference voltage relates to the over-load protection detection. Therefore, because, the input voltage VIN is the fixed value after the time T1, operation of the controller 100 in FIG. 10 after the time T1 is the same as operation of the controller 100 in FIG. 9 after the time T1, so further description thereof is omitted for simplicity.

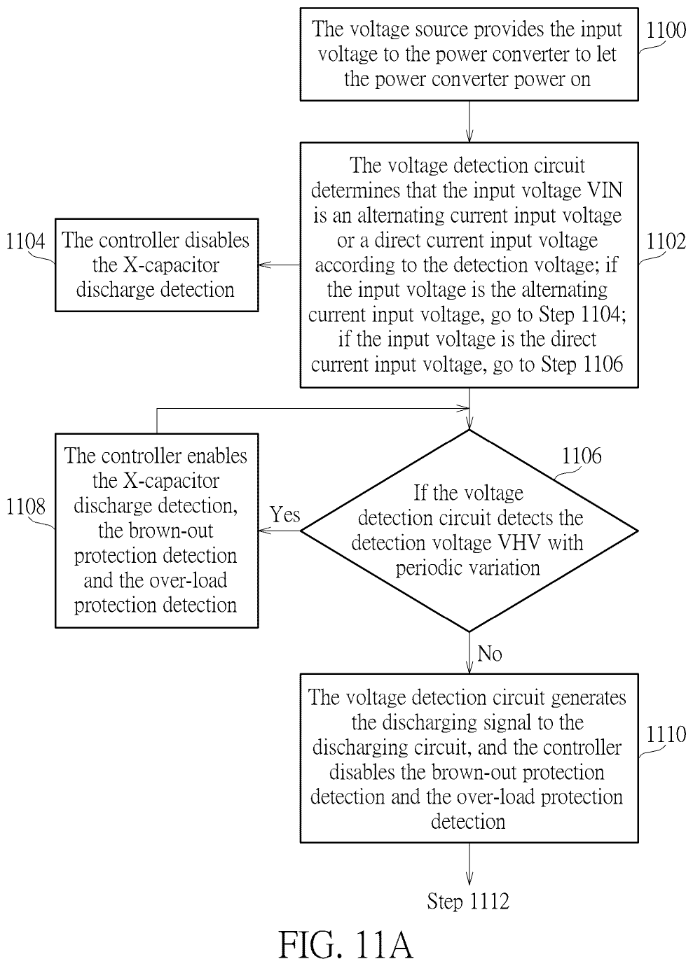

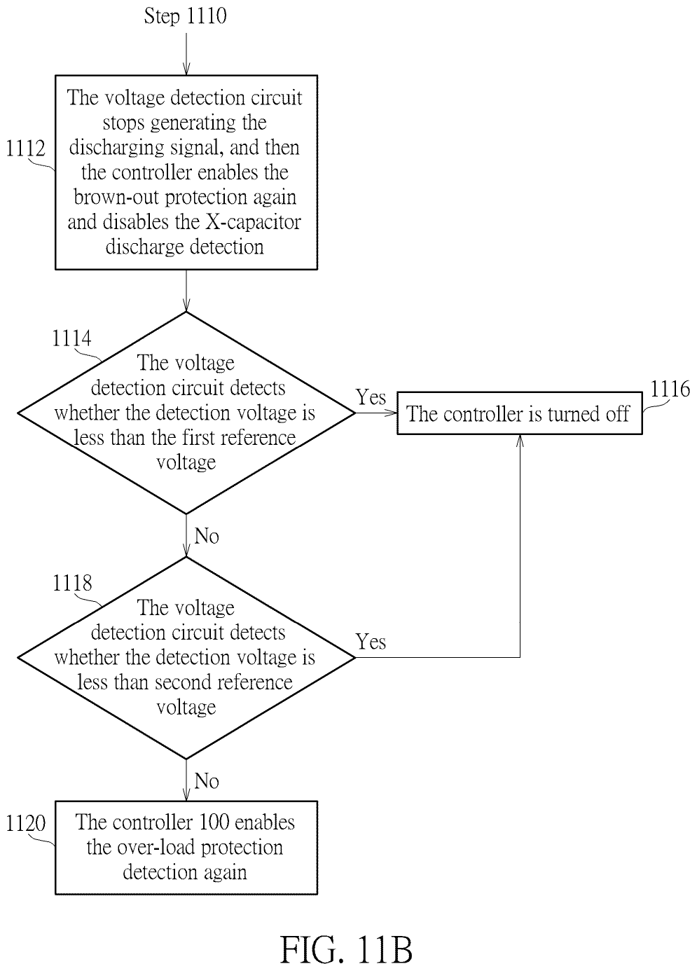

In addition, please refer to FIG. 1, FIG. 2, FIG. 3, FIG. 4, FIG. 8, FIG. 9, FIG. 10, FIG. 11A and FIG. 11B, wherein FIG. 11A and FIG. 11B are flowcharts illustrating an operational method of the controller 100 with variable X-capacitor discharging mechanism according to a fourth embodiment of the present invention. The operational method in FIG. 11A and FIG. 11B is illustrated using the power converter 200 and the controller 100 in FIG. 1. Detailed steps are as follows:
Step 1100: The voltage source 400 provides the input voltage VIN to the power converter 200 to let the power converter 200 power on.
Step 1102: The voltage detection circuit 102 determines that the input voltage VIN is an alternating current input voltage or a direct current input voltage according to the detection voltage VHV; if the input voltage VIN is the alternating current input voltage, go to Step 1104; if the input voltage VIN is the direct current input voltage, go to Step 1106.
Step 1104: The controller 100 disables the X-capacitor discharge detection.
Step 1106: If the voltage detection circuit 102 detects the detection voltage VHV with periodic variation; if yes, go to Step 1108; if no, go to Step 1110.
Step 1108: The controller 100 enables the X-capacitor discharge detection, the brown-out protection detection and the over-load protection detection, go to Step 1106.
Step 1110: The voltage detection circuit 102 generates the discharging signal DS to the discharging circuit 104, and the controller 100 disables the brown-out protection detection and the over-load protection detection.
Step 1112: The voltage detection circuit 102 stops generating the discharging signal DS, and then the controller 100 enables the brown-out protection again and disables the X-capacitor discharge detection.
Step 1114: The voltage detection circuit 102 detects whether the detection voltage VHV is less than the first reference voltage; if yes, go to Step 1116; if no, go to Step 1118.
Step 1116: The controller 100 is turned off.
Step 1118: The voltage detection circuit 102 detects whether the detection voltage VHV is less than second reference voltage; if yes, go to Step 1116; if no, go to Step 1120.
Step 1120: The controller 100 enables the over-load protection detection again.

The execution sequence of Step 1100 (corresponding to the time T0), Step 1102, Step 1106 (corresponding to the time T1˜the time T2), Step 1110 (corresponding to the time T2˜the time T3), Step 1112 (corresponding to the time T3), Step 1114 (corresponding to the time T3˜the time T4), Step 1116 (corresponding to the time T4) can be referred to corresponding descriptions of FIG. 2, the execution sequence of Step 1110, Step 1102, Step 1106, Step 1110, Step 1112, Step 1114, Step 1116 can be referred to corresponding descriptions of FIG. 3, the execution sequence of Step 1110, Step 1102, Step 1106, Step 1110, Step 1112, Step 1114, Step 1118 can be referred to corresponding descriptions of FIG. 4, the execution sequence of Step 1110, Step 1102, Step 1104 the execution sequence of FIG. 9, and the execution sequence of Step 1110, Step 1102, Step 1104 the execution sequence of FIG. 10, so further description thereof is omitted for simplicity.

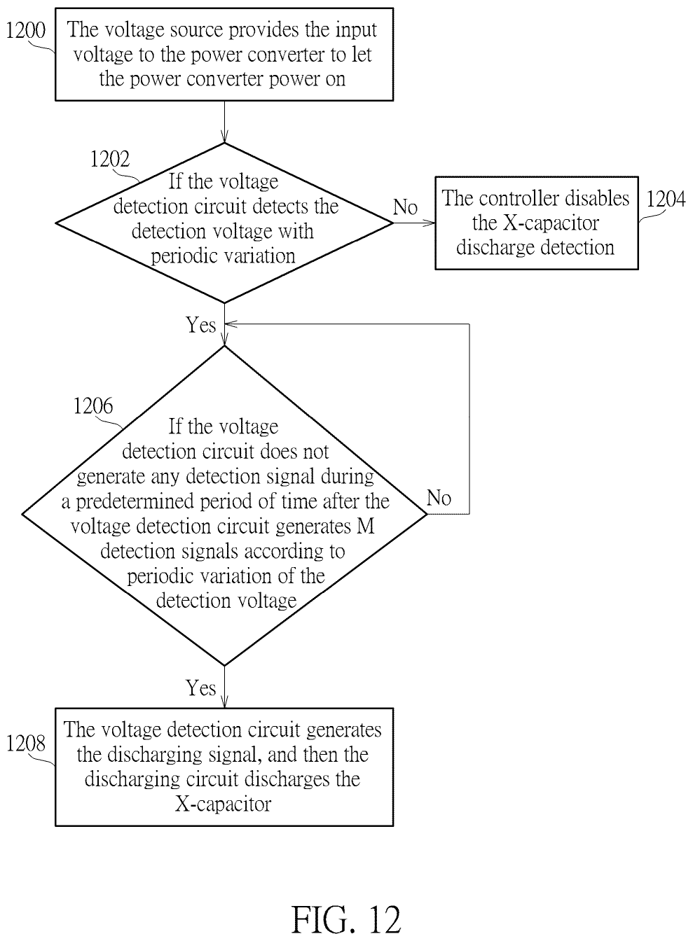

In addition, please refer to FIG. 5, FIG. 6, FIG. 7 and FIG. 12, wherein FIG. 12 is a flowchart illustrating an operational method of the controller 100 with variable X-capacitor discharging mechanism according to a fifth embodiment of the present invention. The operational method in FIG. 12 is illustrated using the power converter 200 and the controller 100 in FIG. 1. Detailed steps are as follows:
Step 1200: The voltage source 400 provides the input voltage VIN to the power converter 200 to let the power converter 200 power on.
Step 1202: If the voltage detection circuit 102 detects the detection voltage VHV with periodic variation; if yes, go to Step 1206; if no, go to Step 1204.
Step 1204: The controller 100 disables the X-capacitor discharge detection.
Step 1206: If the voltage detection circuit 102 does not generate any detection signal S1 during a predetermined period of time after the voltage detection circuit 102 generates M detection signals S1 according to periodic variation of the detection voltage VHV; if yes, go to Step 1208; if no, execute Step 1206 again.
Step 1208: The voltage detection circuit 102 generates the discharging signal DS, and then the discharging circuit 104 discharges the X-capacitor 300.

The execution sequence of Step 1200, Step 1202, Step 1206, Step 1206, Step 1206 . . . can be referred to corresponding descriptions of FIG. 5, Step 1200, the execution sequence of Step 1202, Step 1206, Step 1208 can be referred to corresponding descriptions of FIG. 6, and the execution sequence of Step 1200, Step 1202, Step 1204 can be referred to corresponding descriptions of FIG. 7, so further description thereof is omitted for simplicity.

To sum up, compared to the prior art, the controller with variable X-capacitor discharging mechanism not only can be applied for a power supply that requires compatibility between the AC input voltage and the DC input voltage, but can also prevent the X-capacitor from being continuously discharged to cause the risk of damage and over-temperature of the controller when the input voltage VIN is the DC input voltage because the discharge signal only lasts for a limited period of time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller with variable X-capacitor discharging mechanism, wherein the controller is applied to a power converter and the X-capacitor is coupled to the power converter, the controller comprising:
a voltage detection circuit for receiving a detection voltage through a pin of the controller and determining whether to generate a discharging signal according to variation of the detection voltage, wherein the detection voltage is generated by an input voltage inputted to the power converter, the input voltage is an alternating current input voltage or a direct current input voltage, and the discharging signal lasts for a predetermined period of time; and
a discharging circuit coupled to the voltage detection circuit and the pin, wherein the discharging circuit is used for discharging the X-capacitor according to the discharging signal.

2. The controller of claim 1, wherein the pin is coupled to two ends of the X-capacitor and the X-capacitor is coupled to a bridge rectifier comprised in the power converter.

3. The controller of claim 2, wherein when the input voltage is the alternating current input voltage and the detection voltage does not have periodic variation within a first predetermined period of time, the voltage detection circuit generates the discharging signal after the first predetermined period of time and the discharging circuit discharges the X-capacitor through a discharging current and the pin, wherein the predetermined period of time is greater than the first predetermined period of time.

4. The controller of claim 3, wherein during the first predetermined period of time, the controller enables X-capacitor discharge detection, brown-out protection detection and over-load protection detection.

5. The controller of claim 4, wherein during the predetermined period of time, the controller disables the brown-out protection detection and the over-load protection detection, the controller enables the brown-out protection detection again and disables the X-capacitor discharge detection after the predetermined period of time is finished, and after a second predetermined period of time after the controller enables the brown-out protection detection again and when the detection voltage is less than a first reference voltage, the controller enables brown-out protection, wherein the first reference voltage relates to the brown-out protection detection.

6. The controller of claim 2, wherein when the input voltage is the direct current input voltage and the detection voltage is a fixed value during the first predetermined period of time, the voltage detection circuit generates the discharging signal after the first predetermined period of time and the discharging circuit discharges the X-capacitor through a discharging current and the pin, wherein the predetermined period of time is greater than the first predetermined period of time.

7. The controller of claim 6, wherein during the first predetermined period of time, the controller enables X-capacitor discharge detection, brown-out protection detection and over-load protection detection.

8. The controller of claim 7, wherein during the predetermined period of time, the controller disables the brown-out protection detection and the over-load protection detection, the controller enables the brown-out protection detection again and disables the X-capacitor discharge detection after the predetermined period of time is finished, and after a second predetermined period of time after the controller enables the brown-out protection detection again and when the detection voltage is less than a first reference voltage, the controller enables brown-out protection, wherein the first reference voltage relates to the brown-out protection detection.

9. The controller of claim 7, wherein during the predetermined period of time, the controller disables the brown-out protection detection and the over-load protection detection, the controller enables the brown-out protection detection again and disables the X-capacitor discharge detection after the predetermined period of time is finished, wherein during the predetermined period of time, the detection voltage is greater than a first reference voltage.

10. The controller of claim 9, wherein after a third predetermined period of time after the predetermined period of time is finished, when the detection voltage is the fixed value and greater than a second reference voltage, the controller enables the over-load protection detection again, wherein the second reference voltage relates to the over-load protection detection.

11. The controller of claim 2, wherein when the voltage detection circuit does not generate one detection signal during a fourth predetermined period of time after the voltage detection circuit generates detection signals according to periodic variation of the detection voltage, the voltage detection circuit generates the discharging signal after the fourth predetermined period of time.

12. The controller of claim 11, wherein when the detection voltage is less than a detection reference voltage after the detection voltage reaches a peak value, the voltage detection circuit generates one detection signal.

13. The controller of claim 2, wherein the voltage detection circuit does not generate one detection signal during a fifth predetermined period of time after a voltage source provides an input voltage to the power converter to let the power converter power on, the voltage detection circuit does not generate the discharging signal after the fifth predetermined period of time.

14. The controller of claim 1, wherein the pin is coupled to an output terminal of a bridge rectifier comprised in the power converter, and the X-capacitor is coupled to the bridge rectifier.

15. The controller of claim 14, wherein when the input voltage is the alternating current input voltage and the detection voltage is a fixed value during a first predetermined period of time, the controller disables x-capacitor discharge detection and continuously enables brown-out protection detection and over-load protection detection, wherein the fixed value is greater than a first reference voltage and a second reference voltage, the first reference voltage relates to the brown-out protection detection, and the second reference voltage relates to the over-load protection detection.

16. The controller of claim 14, wherein when the input voltage is the direct current input voltage and the detection voltage is a fixed value during a first predetermined period of time, the controller disables X-capacitor discharge detection and continuously enables brown-out protection detection and over-load protection detection, wherein the fixed value is greater than a first reference voltage and a second reference voltage, the first reference voltage relates to the brown-out protection detection, and the second reference voltage relates to the over-load protection detection.

17. An operational method of a controller with variable X-capacitor discharging mechanism, wherein the controller is applied to a power converter, the X-capacitor is coupled to the power converter, and the controller comprises a voltage detection circuit and a discharging circuit, the operational method comprising:
the voltage detection circuit receiving a detection voltage through a pin of the controller, and determining whether to generate a discharging signal according to variation of the detection voltage, wherein the detection voltage is generated by an input voltage inputted to the power converter, the input voltage is an alternating current input voltage or a direct current input voltage, and the discharging signal lasts for a predetermined period of time; and
the discharging circuit discharging the X-capacitor according to the discharging signal.

18. The operational method of claim 17, wherein when the input voltage is the alternating current input voltage and the detection voltage does not have periodic variation within a first predetermined period of time, the voltage detection circuit generates the discharging signal after the first predetermined period of time, wherein the predetermined period of time is greater than the first predetermined period of time.

19. The operational method of claim 17, wherein when the input voltage is the direct current input voltage and the detection voltage is a fixed value within the first predetermined period of time, the voltage detection circuit generates the discharging signal after the first predetermined period of time, wherein the predetermined period of time is greater than the first predetermined period of time.
